(19) United States
(12) Patent Application Publication
(10) Pub. No.: US 2015/0176551 A1
(43) Pub. Date: Jun. 25, 2015

(54) INTEGRATED PWM FUEL PUMP DRIVER MODULE

(71) Applicants: Michael R. Teets, Grosse Pointe, MI (US); Paul J. Luft, Novi, MI (US); Greg Schoenberg, Fenton, MO (US)

(72) Inventors: Michael R. Teets, Grosse Pointe, MI (US); Paul J. Luft, Novi, MI (US); Greg Schoenberg, Fenton, MO (US)

(21) Appl. No.: 14/571,886

(22) Filed: Dec. 16, 2014

Related U.S. Application Data
(60) Provisional application No. 61/918,735, filed on Dec. 20, 2013.

(51) Int. Cl. F02M 37/08

(52) U.S. Cl. CPC F02M 37/08; F02M 2037/085

(57) ABSTRACT

In accordance with an aspect of the present disclosure, an integrated PWM fuel pump driver module includes a circuit board on which at least one power semiconductor is disposed and a fuel tube downstream of a fuel pump controlled by the driver module. The fuel flowing through the fuel tube cools each power semiconductor as heat is transferred from each power semiconductor into the fuel.

### CROSS-REFERENCE TO RELATED APPLICATIONS

This application claims the benefit of U.S. Provisional Application No. 61/918,735, filed on Dec. 20, 2013. The entire disclosure of the above application is incorporated herein by reference.

### FIELD

The present disclosure relates to an integrated pulse width modulated (PWM) fuel pump driver module for driving electric fuel pumps.

### BACKGROUND

One type of fuel pump used in vehicles having gasoline or diesel engines is an electric fuel pump. Electric fuel pumps are often driven by PWM fuel pump driver modules that having switched power semiconductors that are switched on and off at duty cycle that runs the electric fuel pump to provide a requisite fuel flow to the engine. The duty cycle is increased or decreased as needed to provide the requisite fuel flow. The power semiconductors may be any type of power semiconductors such as MOSFETS, SCR's, thyristors or dedicated power drivers such as half-bridge or full bridge power drivers, for example the Infineon BTN 8982 power driver.

FIG. 1 is a basic schematic of a fuel supply system 100 in a vehicle 102 having a fuel tank 104, an electric fuel pump 106, a pressure transducer 108, an engine 110 and a fuel pump control module 112. In some cases, the fuel pump control module 112 includes a pressure relief valve. It should be understood that the pressure relief valve is optional. It should also be understood that electric fuel pump 106 may be mounted within fuel tank 104. Pressure transducer 108 is in series with fuel line 109 between electric fuel pump 106 and engine 110 so that fuel being pumped by electric fuel pump 106 flows through pressure transducer 108. Fuel pump control module 112 includes one or more power semiconductors 114 and a controller 116.

Electric fuel pump 106 may be park of a fuel delivery module that includes a flange assembly, sometimes called a fuel delivery module flange, electrically and hydraulically connected to the electric fuel pump. The fuel delivery module flange seals an opening in the fuel tank with the electric fuel pump disposed in a reservoir of the fuel delivery module. The fuel delivery module may have fuel filter, in which case it has a filter, and also regulate the fuel pressure as it is pumped under pressure by the electric fuel pump, measure fuel in the fuel tank, and maintain fuel at an inlet of the fuel pump during low fuel driving conditions (such as when the fuel tank is approaching empty), such as having a low fuel reservoir that it keeps filled during low fuel driving conditions.

One type of control approach for operating electric fuel pump 106 is operating it to maintain the fuel flowing to the engine 110 at a desired pressure. This desired pressure is for an example an adjustable pressure set point based on engine calibration command or preset to a predetermined pressure. The power semiconductors 114 are switched by controller 116 that adjusts a duty cycle to maintain the desired pressure. Pressure transducer 108 senses the pressure of the fuel flowing to engine 110 and provides a feedback signal to the controller 116 which calculates and adjusts the duty cycle at which to switch the power semiconductors 114 and switches them accordingly.

In some cases, a pressure regulator 118 shown in phantom in FIG. 1 is disposed in fuel line 109 downstream of electric fuel pump 106. Pressure regulator 118 is illustratively set a few PSI above a maximum pressure limit that limits the maximum pressure at which controller 116 runs electric fuel pump 106. This for example allows controller 116 to run electric fuel pump 106 at full on (100% duty cycle) such as in the event that pressure transducer 108 fails, with pressure regulator 118 then regulating the pressure in fuel line 109 downstream of electric fuel pump 106.

Power semiconductors generate heat due to electrical current flowing through them. It is thus necessary to cool the power semiconductors. Often, this is accomplished by mounting the power semiconductors on heat sinks and dissipating heat to the atmosphere, which in many cases includes directing air over the heat sinks so that the heat dissipates to the atmosphere.

### SUMMARY

In accordance with an aspect of the present disclosure, an integrated PWM fuel pump driver module includes a circuit board on which at least one power semiconductor and a controller are mounted. The controller is configured to switch each power semiconductor at a duty cycle determined by the controller to maintain a pressure of fuel being pumped by the fuel pump being driven by the integrated PWM fuel pump driver module at a desired pressure level. The integrated PWM fuel pump driver module further includes a fuel tube through which fuel being pumped by the electric fuel pump flows. Each power switching semiconductor is cooled by fuel flowing through the fuel tube.

In an aspect, each fuel tube is made of a thermally conductive material and is thermally coupled with each power semiconductor. In an aspect, the fuel tube is made of a thermally conductive material such as steel, brass or aluminum. In an aspect, the fuel tube made of thermally conductive material is in close proximity to each power semiconductor. In an aspect, the fuel tube made of thermally conductive material is in direct physical contact with each power semiconductor. In an aspect, the fuel tube made of thermally conductive material is in direct physical contact with a conductive trace of the circuit board on which each power semiconductor is disposed and in an aspect, is in direct physical contact with each power semiconductor and also with the conductive trace. In an aspect, each power semiconductor is mounted to a heat sink and the fuel tube made of thermally conductive material is in direct physical contact with each heat sink.

In an aspect, the integrated PWM fuel pump driver module includes a housing in which the circuit board and fuel tube are disposed. In an aspect, the circuit board is potted with a thermally conductive potting material that at least partially fills the housing. In an aspect, the fuel tube includes a fuel inlet diametrically opposite each power semiconductor.

In an aspect, the integrated PWM fuel pump driver module includes a housing in which the circuit board is disposed. The fuel tube is disposed external to an interior of the housing and a heat sink member extends from the fuel tube into the interior of the housing and is thermally coupled to each power semiconductor and to fuel flowing through the fuel tube. In an aspect, the heat sink member is in direct physical contact with each power semiconductor and the fuel flowing through the fuel tube.

In an aspect, a pressure transducer that senses pressure in the fuel tube is coupled to the controller.

In an aspect, the circuit board of the PWM fuel pump driver module includes a pressure sensing element assembly of a pressure transducer. The pressure transducer also includes a pressure inlet port in fluid communication with a pressure sensing element of the pressure sensing element assembly and a portion of a fuel line downstream of the electric fuel pump, which in an aspect is the fuel tube.

In an aspect, the circuit board includes a controller that is configured to control the duty cycle of each power semiconductor in response to a feedback signal from the pressure transducer so that fuel is pumped by the fuel pump at a desired pressure level. In an aspect, a pressure regulator is in a portion of the fuel line downstream of the pump.

In an aspect, the fuel tube includes a temperature sensor that senses temperature of the fuel flowing through the fuel tube with the temperature sensor coupled to the controller. The controller includes calibratable pressure set points that vary with temperature and the controller is configured to further use the calibratable pressure set points for the temperature sensed by the temperature sensor in determining the duty cycle at which to switch the power semiconductors.

In an aspect, the controller is configured so that it is responsive to a signal from an engine control unit to change the desired pressure level to a level indicated by the signal from the engine control unit.

In an aspect, the integrated PWM fuel pump driver module is disposed in a fuel delivery module flange.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a basic schematic of a prior art fuel supply system for a vehicle;

FIG. 2 is a perspective view of a fuel delivery module flange having an integrated PWM fuel pump driver module in accordance with an aspect of the present disclosure;

FIG. 3 is a basic schematic of a fuel supply system incorporating the integrated PWM fuel pump driver module of FIG. 2;

FIG. 4 is an exploded view of a portion of the integrated PWM fuel pump driver module of FIG. 2;

FIG. 5 is a basic block diagram of the integrated PWM fuel pump driver module in accordance with an aspect of the present disclosure that is a variation of the integrated PWM fuel pump driver module of FIG. 2;

FIG. 6 is a basic block diagram of an integrated PWM fuel pump driver module in accordance with an aspect of the present disclosure in which a circuit board includes a pressure sensing element assembly of a pressure transducer; and

FIG. 7 is a flow chart of illustrative control logic for control of the integrated fuel pump driver module in accordance with an aspect of the present disclosure.

### DETAILED DESCRIPTION

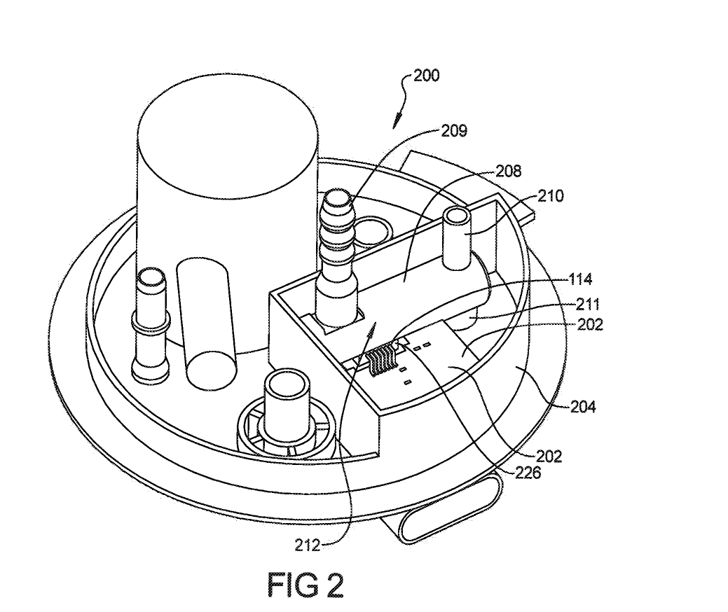

FIG. 3 is a basic schematic of a fuel supply system 100′ incorporating an integrated PWM fuel pump driver module 200 (FIG. 2) in accordance an aspect of the present disclosure. In the embodiment shown in FIG. 2, integrated PWM fuel pump driver module 200 is disposed in a fuel delivery module flange 224. With reference to FIGS. 2 and 3, integrated PWM fuel pump driver module 200 includes a circuit board 202 (FIG. 2) disposed in a housing 204 that includes a cover (not shown in the drawings) covering the top (as oriented in FIG. 2) of the housing 204. One or more power semiconductors 114 are mounted to circuit board 202. The power semiconductors 114 are cooled by fuel flowing through a fuel tube 208. In this regard, fuel tube 208 is a portion of a fuel line downstream of the electric fuel pump. In this regard, power semiconductors 114 are thermally coupled to fuel flowing through fuel tube 208, as discussed below with regard to various aspects. In this regard, as used herein, the power semiconductors being thermally coupled to the fuel flowing through the fuel tube means that there is a heat flow path by which heat flows from the power semiconductors to the fuel in fuel tube 208. For example, the heat can flow directly from the semiconductors to the fuel tube 208 and through fuel tube 208 into the fuel flowing through fuel tube 208, or can flow through an intermediary component such as a heat sink to the fuel flowing through fuel tube 208.

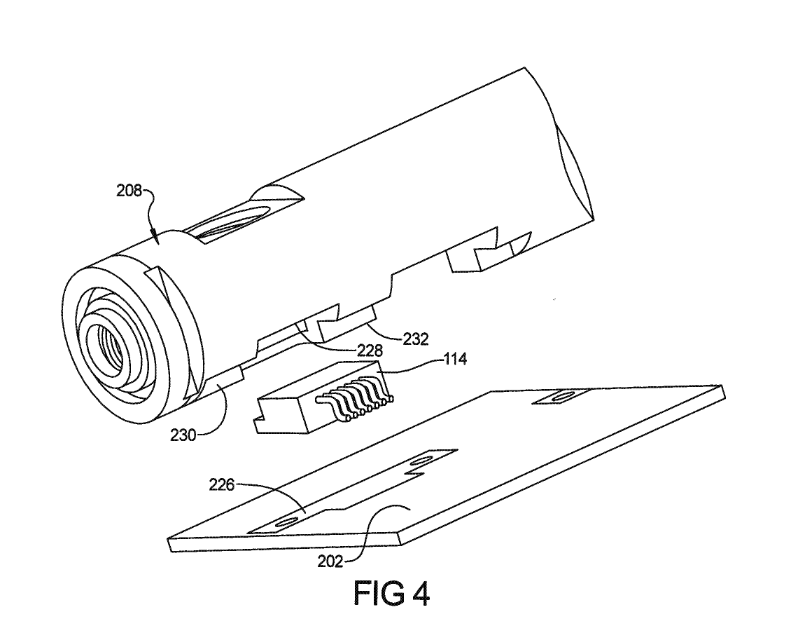

In the embodiment of FIG. 2, fuel tube 208 is disposed in housing 204 and is thermally coupled to each power semiconductor 114 and is thus integrated in the same package (e.g., housing 204) as other elements of integrated PWM fuel pump driver module 200, including power semiconductors 114. In an aspect, housing 204 is illustratively formed as part of fuel delivery module flange 224. Fuel tube 208 includes a fuel inlet 209 into which fuel flows from electric fuel pump 106 and a fuel outlet 211 out of which fuel flows to engine 110. In an aspect, fuel inlet 209 is diametrically opposite each power semiconductor 114, though it should be understood that it need not be. In the embodiment shown in FIG. 2, fuel tube 208 directly physically contacts each power semiconductor 114, such as by being mounted so that it is in physical contact with top surfaces of each power semiconductor 114. It should be understood, however, that the power semiconductors 114 could be mounted on a heat sink (or heat sinks) or a conductive trace(s) (which could be or include a pad(s)) on the circuit board 202 that acts as a heat sink and fuel tube 208 directly physically contacting the heat sink(s) or copper trace(s)/pad(s). In this regard, as used herein, the fuel flowing through fuel tube 208 being thermally coupled to the power semiconductors means that there is a heat flow path where heat flows from the power semiconductors to the fuel flowing through fuel tube 208 directly or through an intermediary component such as a heat sink. In an aspect, fuel tube 208 is in direct physical contact with the power semiconductor(s) 114 and to a conductive trace(s) 226 (FIG. 4) on which power semiconductor(s) 114 is mounted. In this aspect, fuel tube 208 has a recess 228 (best shown in FIG. 4) in which power semiconductor(s) 114 is received with sections 230, 232 of fuel tube 208 on opposed sides of recess 228 contacting conductive trace(s) 226. Conductive trace(s) 226 is a conductive trace(s) of printed circuit board 202 and may be a copper trace, but could be other conductive materials.

In the embodiment shown in FIG. 2, as discussed, integrated PWM fuel pump driver module 200 is disposed in fuel delivery module flange 224 and in an aspect is potted with a thermally potting conductive material to protect the electronics from the environment and aid in the dissipation of heat from power semiconductors 114 to fuel tube 208 and the surrounding environment. Illustratively, housing 204 can be filled or partially filled with the thermally conductive potting material to pot the components of integrated PWM fuel pump driver module 200, power semiconductor(s) 114 and controller 214 in particular. Thermally conductive potting material may be an 832TC thermally conductive epoxy encapsulating and potting compound available from MG Chemicals of Burlington, Ontario, but it should be understood that it can be other types of thermally conductive potting material. In the embodiment shown in FIG. 2, housing 204 is on a bottom side of the fuel delivery module flange 224. It should be understood that housing 204 could be on a top side of the fuel delivery module flange 224.

Fuel tube 208 is coupled in series in the fuel line 109 between the electric fuel pump 106 being driven by integrated PWM fuel pump driver module 200 and engine 110 of vehicle 102 so that fuel being pumped by the electric fuel pump 106 flows through fuel tube 208 as it flows to the engine. Since fuel tube 208 is in series between electric fuel pump 106 and engine 100, fuel tube 208 is considered as part of the fuel line downstream of electric fuel pump 106 even though it for example it is a separate component. Also in the embodiment shown in FIGS. 2 and 3, fuel tube 208 includes a pressure transducer 210 that senses the pressure of fuel flowing through fuel tube 208, the combination of fuel tube 208 and pressure transducer 210. Circuit board 202 includes controller 214 to which pressure transducer 210 is coupled. In response to a pressure feedback signal provided by pressure transducer 210, controller 214 switches power semiconductors 114 at a duty cycle determined by controller 214 to maintain fuel being pumped by electric fuel pump 106 being driven by integrated PWM fuel pump driver module 200 at a desired pressure.

In an aspect, fuel tube 208 is made of a thermally conductive material, such as steel, brass or a non-metallic thermally conductive material.

Since the power semiconductors 114 are thermally coupled to the fuel flowing through fuel tube 208, the fuel flowing through fuel tube 208 cools power semiconductors 114 and in the embodiment shown in FIG. 2, allows separate heat sinks to be eliminated, with fuel tube 208 providing the heat sink for each power semiconductor 114. In the embodiment of FIG. 2, fuel tube 208 is in direct physical contact with power semiconductors 114. It should be understood, however, that the power semiconductors could mounted to a heat sink (or heat sinks) with fuel tube 208 in direct physical contact with the heat sink(s).

Further, power semiconductors 114 will generate more heat as the duty cycle at which they are being switched increases. The increase in duty cycle also results in an increase in the amount of fuel being pumped, which results in additional cooling of the power semiconductors 114 due to the fuel flowing through fuel tube 208 since more fuel is flowing through fuel tube 208.

In addition to other advantages described herein, another advantage provided by the integration of fuel tube 208 with pressure transducer 210 in the same package as power semiconductors 114 and controller 214 is the reduction of electromagnetic interference compared to prior art PWM electric fuel pump driver modules. Due to the increased cooling efficiency this integration provides, the slew rate for switching the power semiconductors on and off can be slowed without overheating the power semiconductors. As is known by those of ordinary skill in the art, slowing the rise and fall times of switching circuits reduces electromagnetic interference both radiated and conducted, but at a cost of increased heat generation. In most cases, this is often a critical design trade off. By slowing the rise and fall times electromagnetic interference can be reduced but at the cost of overheating the part or increasing the size and cost of the heat sink. Another benefit of slower rise and fall times is that it allows for use of smaller, less expensive EMI filters.

In an aspect, controller 214 includes an input 216 coupled to an engine control unit (ECU) 218 to which ECU 218 can send a signal to change the pressure set point to which controller 214 controls the pressure of the fuel being pumped by electric fuel pump 106. Controller 214 responds to the signal from ECU 218 and changes the pressure set point to a value indicated by the signal sent from ECU 218. This is particularly advantageous for high output engines because it allows for the expansion of the dynamic range of fuel injectors of the engine by varying the fuel pressure at the injectors. The pressure set point can be set by ECU 218 many milliseconds in advance of engine 110 reaching full horsepower (and thus full fuel flow) by anticipating future fuel demand based on throttle position or other indicators. Typically, there is a several hundred millisecond horsepower ramp up period which is much slower than the response time of controller 214, which is typically on the order of a few milliseconds.

In an aspect, an inside of fuel tube 208 is coated or plated with different materials such as anodized aluminum to provide protection against hostile fuels. In an aspect, pressure transducer 210 is coated with a fluorocarbon gel and/or Parylene C.

It should be understood that integrated PWM fuel pump driver module 200 may be mounted internally in fuel tank 104, such as with electric fuel pump 106, or it may be mounted externally to the fuel tank 104.

In an aspect, fuel tube 208 includes a temperature sensor 220 (shown in phantom in FIG. 3) coupled to controller 214. The controller includes calibratable pressure set points that vary with temperature (e.g., a set of calibratable pressure set points where each calibratable pressure set point is for a different temperature). In this aspect, the controller further uses the calibratable pressure set point for the temperature sensed by the temperature sensor in determining the duty cycle at which to switch the power semiconductors. The calibratable pressure set point typically increases with increasing temperature. The exact function P(t) may be linear, non-linear or a series of steps.

In an aspect, controller 214 has a minimum duty cycle at which it switches the power semiconductors 114 to maintain a minimum pressure in the fuel line downstream of the electric fuel pump 106. If the duty cycle the controller determines is less than this minimum duty cycle, the controller 214 uses the minimum duty cycle as the duty cycle at which to switch the power semiconductors 114 to maintain a minimum pump speed which improves response time during tip in after an injector off cycle. An injector off cycle is typically incurred by a vehicle when coasting down long hills. Otherwise, the controller 214 uses the determined duty cycle as the duty cycle at which to switch the power semiconductors 214.

FIG. 7 is a flow chart of illustrative control logic of controller 214 for the above control. At 700, the control logic starts. At 702, controller 214 reads the pressure transducer 108 to obtain the pressure in the fuel line downstream of electric pump 106 and at 704 reads the temperature sensor 220 to obtain the temperature in the fuel line downstream of electric pump 106. At 706, controller 214 receives the desired pressure level from ECU 218 and at 708, controller 214 determines the duty cycle at which to switch the power semiconductors 214. It does so using the pressure sensed by pressure transducer 108, the calibratable pressure setpoint for the temperature sensed by temperature sensor 220, and the desired pressure level from ECU 218, as discussed above. At 710, controller 214 checks whether the determined duty cycle is less than the minimum duty cycle. If not, controller 214 branches to 712 and uses the determined duty cycle as the duty cycle at which to switch power semiconductors 114. If so, controller 214 branches to 714 and uses the minimum duty cycle as the duty cycle at which to switch power semiconductors 114. In either case, controller 214 then branches back to 702.

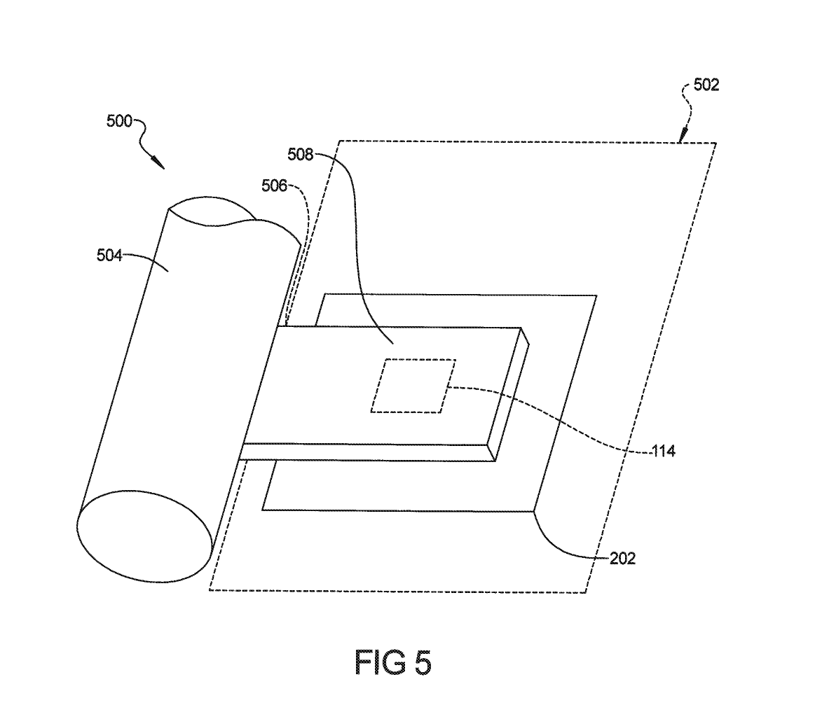

FIG. 5 shows an integrated PWM fuel pump driver module 500 in accordance with an aspect of the present disclosure that is a variation of integrated PWM fuel pump driver module 200. Integrated fuel pump driver module 500 includes housing 502 with a fuel tube 504 disposed external to an interior of housing 502, such as by being mounted to an exterior 506 of housing 502. Fuel pumped by fuel pump 106 flows through fuel tube 504. A heat sink member 508 made of thermally conductive material extends from fuel tube 504 into housing 502 and is thermally coupled to fuel flowing through fuel tube 504 and to each power semiconductor 114. In the example shown in FIG. 5, heat sink member 508 is in direct physical contact with each power semiconductor 114, such as by contacting tops of the power semiconductors 114 with the power semiconductors sandwiched between heat sink member 508 and circuit board 202. As discussed above, each power semiconductor 114 could be mounted on a heat sink (or heat sinks) or a conductive trace(s) (which could be or include a pad(s)) on the circuit board 202 that acts as a heat sink and heat sink member 508 directly physically contacting the heat sink(s) or copper trace(s)/pad(s). In an aspect, fuel tube 504 is also made of thermally conductive material.

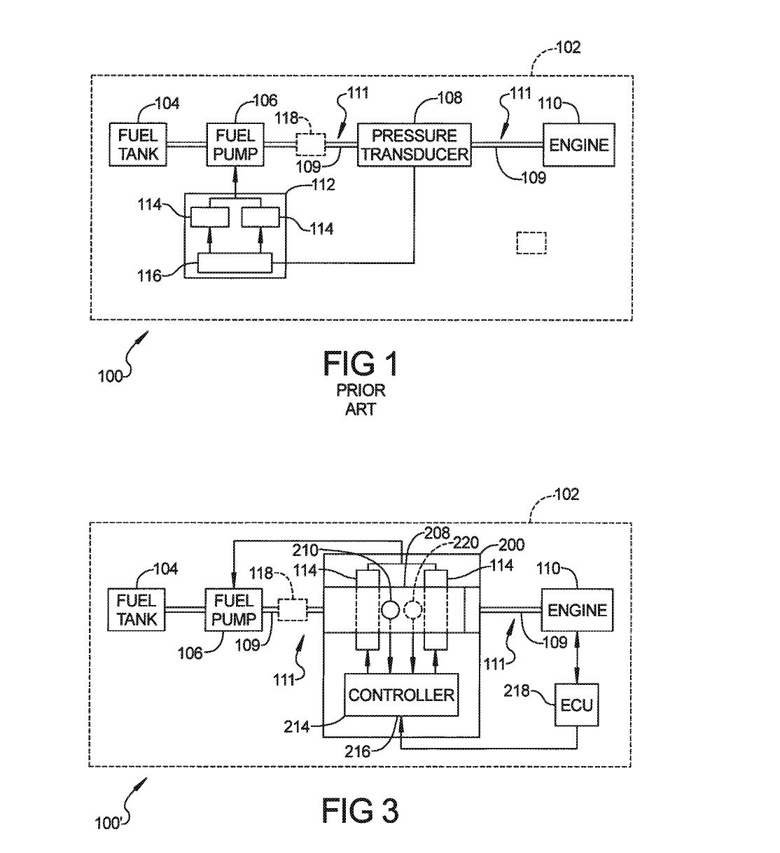

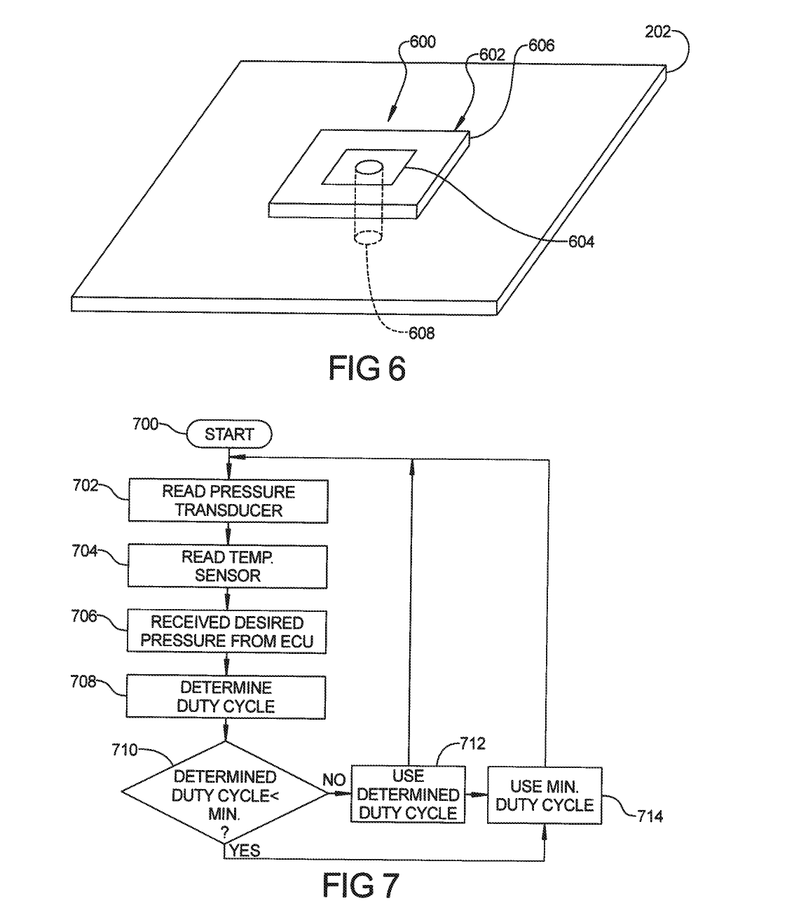

In an aspect with reference to FIG. 6, circuit board 202 includes a pressure sensing element assembly 602 of a pressure transducer 600. Pressure sensing element assembly 602 includes a pressure sensing element 604 mounted on a pressure transducer circuit board 606 which is mounted on circuit board 202. Pressure transducer 600 also includes a pressure inlet port 608 in fluid communication with the pressure sensing element 604 and a portion 111 (FIGS. 1 and 3) of fuel line 109 downstream of the pump, such as in fuel tube 208 or 504. In the latter case, regard, the pressure inlet port 606 is in fluid communication with fuel tube 208 or fuel tube 504.

It should be understood that controller 214 may be, be part of, or include an Application Specific Integrated Circuit (ASIC); an electronic circuit; a combinational logic circuit; a field programmable gate array (FPGA); a processor (shared, dedicated, or group) that executes code; a programmable logic controller, programmable control system such as a processor based control system including a computer based control system, a process controller such as a PID controller, or other suitable hardware components that provide the described functionality or provide the above functionality when programmed with software as described herein; or a combination of some or all of the above, such as in a system-on-chip. The term module may include memory (shared, dedicated, or group) that stores code executed by the processor. The term software, as used above, may refer to computer programs, routines, functions, classes, and/or objects and may include firmware, and/or microcode. When it is stated that controller 214 performs a function such as switching power semiconductors 114, it should be understood that controller 214 is configured to do so such as by appropriate software, electronic circuit(s) including discrete and integrated logic, or combination thereof. Controller 214 may include calibratable set points.

The apparatuses and methods described herein may be implemented by software in one or more computer programs executed by one or more processors of one or more controllers. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An integrated PWM fuel pump driver module for driving an electric fuel pump, comprising:
a circuit board on which at least one power semiconductor and a controller are mounted;
the controller configured to switch each power semiconductor at a duty cycle determined by the controller to maintain a pressure of fuel being pumped by the electric fuel pump being driven by the integrated PWM fuel pump driver module at a desired pressure level; and
a fuel tube through which fuel being pumped by the electric fuel pump flows, each power semiconductor thermally coupled to the fuel flowing through the fuel tube wherein the fuel flowing through the fuel tube cools each power semiconductor.

2. The integrated PWM fuel pump driver module of claim 1 wherein the fuel tube is made of a thermally conductive material and is thermally coupled to each power semiconductor.

3. The integrated PWM fuel pump driver module of claim 2 wherein the fuel tube is in direct physical contact with each power semiconductor.

4. The integrated PWM fuel pump driver module of claim 3 wherein the fuel tube is also in direct physical contact with a conductive trace of the circuit board on which each power semiconductor is mounted.

5. The integrated PWM fuel pump driver module of claim 2 wherein the fuel tube is in direct physical contact with a conductive trace of the circuit board on which each power semiconductor is mounted.

6. The integrated PWM fuel pump driver module of claim 2 wherein the fuel tube includes a fuel inlet diametrically opposite each power semiconductor.

7. The integrated PWM fuel pump driver module of claim 1 including a housing in which the circuit board is disposed that includes a pressure sensing element assembly of a pressure transducer, the pressure transducer also including a pressure inlet port in fluid communication with a pressure sensing element of the pressure sensing element assembly and fuel flowing downstream of the electric fuel pump.

8. The integrated fuel pump driver module of claim 7 wherein the circuit board is potted with a thermally conductive potting material that at least partially fills the housing.

9. The integrated PWM fuel pump driver module of claim 1 wherein the controller is coupled to a pressure transducer that senses pressure of fuel flowing downstream of the electric fuel pump, the controller configured to determine the duty cycle at which to switch each power semiconductor based on a pressure feedback signal from the pressure transducer and a desired pressure level.

10. The integrated PWM fuel pump driver module of claim 9 wherein the controller is coupled to a temperature sensor that senses temperature of fuel flowing downstream of the electric fuel pump, the controller including calibratable pressure set points that vary with temperature, the controller further using the calibratable pressure set point for the temperature sensed by the temperature sensor in determining the duty cycle at which to switch each power semiconductor.

11. The integrated PWM fuel pump driver module of claim 9 wherein the controller is configured so that it is responsive to a signal from an engine control unit to change the desired pressure level to a pressure level indicated by the signal from the engine control unit.

12. The integrated PWM fuel pump driver module of claim 11 wherein the controller is configured so that it has a minimum duty cycle at which it switches the power semiconductors to maintain a minimum pressure in the fuel line downstream of the electric fuel pump.

13. The integrated PWM fuel pump driver module of claim 9 and further including a pressure regulator that regulates pressure of fuel flowing downstream of the electric fuel pump.

14. The integrated PWM fuel pump driver module of claim 1 and further including a fuel delivery module flange in which the PWM fuel pump driver module is disposed.

15. The integrated PWM fuel pump driver module of claim 1 including a housing in which the circuit board is disposed, the fuel tube disposed external to an interior of the housing, and a heat sink member that extends from the fuel tube into the interior of the housing, the heat sink member thermally coupled to the fuel flowing in the fuel tube and each power semiconductor to thermally couple each power semiconductor to the fuel flowing in the fuel tube.

16. The integrated PWM fuel pump driver module of claim 15 wherein the heat sink member is in direct physical contact with each power semiconductor.

17. In an integrated PWM fuel pump driver module for driving an electric fuel pump having a circuit board on which at least one power semiconductor and a controller are mounted, a method of cooling the at least one power semiconductor comprising cooling the at least one power semiconductor with fuel flowing through a fuel tube of the integrated fuel pump driver module.

18. The method of claim 17 wherein the fuel tube is made of thermally conductive material and further including transferring heat from the at least one power semiconductor to the fuel tube by having the fuel tube in direct physical contact with the at least one power semiconductor.

19. The method of claim 17 including transferring heat from the at least one power semiconductor to the fuel flowing through the fuel tube with a heat sink member extending from the fuel tube to the at least one power semiconductor.
